(19) United States
(12) Patent Application Publication
(10) Pub. No.: US 2016/0191598 A1
(43) Pub. Date: Jun. 30, 2016

(54) SYSTEM AND METHODS THAT ENABLE EMBEDDING, STREAMING, AND DISPLAYING VIDEO ADVERTISEMENTS AND CONTENT ON INTERNET WEBPAGES ACCESSED VIA MOBILE DEVICES

(71) Applicant: LIKQID MEDIA, INC., Foothill Ranch, CA (US)

(72) Inventors: Brian C. DeFrancesco, Trabuco Canyon, CA (US); Christophe L. Clapp, Corona, CA (US)

(21) Appl. No.: 14/818,228

(22) Filed: Aug. 4, 2015

Related U.S. Application Data
(60) Provisional application No. 62/033,039, filed on Aug. 4, 2014.

(51) Int. Cl. H04L 29/06; G06Q 30/02; H04L 29/08

(52) U.S. Cl. CPC H04L 65/608; H04L 67/02; G06Q 30/0277

(57) ABSTRACT

Disclosed are a system and method of online video streaming and rendering on mobile internet connected devices, in particular streaming of internet video advertisements and internet video content embedded on webpages through a web browser or application WebView. The system and method enable a webpage to embed video content that plays within the web browser app or application WebView using a standard process operable on all mobile devices and which does not require additional browser plug-ins or user initiation to render the video. Furthermore, the system and method provide a real-time process for transcoding video media assets that are encoded in numerous formats to a standard that renders embedded video on any webpage when accessed by a mobile internet connected device.

### CROSS REFERENCE TO RELATED APPLICATIONS

The present application claims priority to U.S. Provisional Application Ser. No. 62/033,039 for “SYSTEM AND METHODS THAT ENABLE EMBEDDING, STREAMING, AND DISPLAYING VIDEO ADVERTISEMENTS AND CONTENT ON INTERNET WEBPAGES ACCESSED VIA MOBILE DEVICES”, filed Aug. 4, 2014 which is hereby incorporated by reference in its entirety and for all purposes.

### FIELD

The field of the invention relates to online video embedding, asset transcoding, streaming, and rendering internet video advertisements and internet video content on webpages for display on mobile internet connected devices.

### BACKGROUND

Historically, websites have had no standard format for embedding, streaming, and displaying videos on web pages that applies across all browsers, operating systems, and consumer devices.

Recently the HTML5 web specification has defined a ‘video’ element which specifies a standard way to embed a video on a web page. However, this standard has been hampered by lack of agreement between developers and the HTML5 Working Group (http://www.w3.org/html/wg/) as to which video formats should be supported in web browsers.

Essentially the only previous option to embed, stream, and display videos on web pages is a web browser ‘plug-in’. A web browser ‘plug-in’ is extra software, usually written by a third party (apart from the web browser creator), which enhances the functionality of the web browser. The most popular software for downloading, streaming, and playing video on personal computers is Adobe's Flash Player plugin for web browsers including Microsoft Internet Explorer, Mozilla Firefox, Google Chrome, Apple Safari, etc.

In 2011, Flash Player emerged as the de facto standard for online video publishing on personal computers. On mobile devices however, Apple refused to allow the Flash Player within the iOS Safari web browser. Flash Player was previously available for Google's Android operating system, although in June 2012, Google announced that Android 4.1 would not support Flash Player by default. Beginning in August 2012, Adobe no longer offered updates to Flash Player for Android.

While HTML5 video support is included in the web browsers on most mobile devices, the current HTML5 draft specification does not specify which video formats web browsers should support. Web browsers are free to support any video formats the web browser developer feels is appropriate and there is no minimal set of video formats to support. The lack of a minimal set of video formats to support makes it difficult for some websites to stream video using HTML5 since websites may receive video content from the content owner or advertiser in only one format while users may visit the website using different browsers, requiring different formats of the video content.

In addition, some mobile devices, such as the Apple iPhone, override the default behavior of the HTML5 video element and redirect the user from the webpage the video is embedded on to consume the video in QuickTime media player. Because QuickTime media player opens and takes control of rendering the video, this limits features such as interactive components, canvas overlays, consumers' ability to click video advertisements, and collection of data on important video metrics that marketers and content owners may use.

Accordingly, systems and methods to enable standard embedding, streaming, control, rendering, content and/or advertisement performance and engagement metrics, and click functionality for online videos on mobile devices is desirable.

### SUMMARY

The systems and methods herein relate to online video embedding, real-time asset transcoding, streaming, and rendering of internet video advertisements and internet video content displayed by webpages on mobile internet connected devices.

These systems and methods provide a standard ability for web pages accessed via mobile devices to embed, stream, control, and display video advertisements and content without the use of web browser plugins or requirements for HTML5 video format support. Furthermore, these systems and methods are not limited by restrictions that may be present for HTML5 video elements or plugins for play initiation, measurement, or web page interaction.

These systems and methods include a website placing a JavaScript file on a webpage and, optionally, creating a video container element (if not one will be created by the JavaScript). In some embodiments the website may already have a predefined area created where a video may render. In many of these embodiments the systems and methods described herein may render the video in the website's predefined area. In embodiments where no predefined area exists, the JavaScript file may create a predefined area as a container element to contain video rendering. The JavaScript file will gather data about the webpage, the user, the browser, and the device to aid in deciding which video content or advertisement should be rendered. Once applicable video content is identified, the JavaScript file will make a request to a proprietary video transcoding system, via a CDN as shown in FIG. 2, to have the video content fetched if has been previously formatted, or if not previously formatted then prepared, in real-time, for rendering. The CDN will source the video content or advertisement from the transcoding servers if not stored on the CDN previously.

In an example embodiment of the data gathering described above, an Advertiser A may wish to play a video advertisement (Ad1) only on Apple brand tablets such as the iPad and an Advertiser B may wish to play a video advertisement (Ad2) only on smart-phones. The JavaScript file may gather data to send to a third party or an Ad Decisioning Platform to determine whether to play Ad1, Ad2, or any other video content or combination of video content according to the wishes of Advertiser A, Advertiser B, or any other advertiser or video content provider. In the example embodiment this can include the JavaScript file gathering data about what type of user device is a being used. The desired ad delivery conditions can be defined by an advertiser, video content provider or system administrator.

A first step in formatting the video for rendering on devices is to take the video received or otherwise acquired from an advertiser or content provider, decode the video and separate audio channels from visual channels.

A visual channel of a video is a static image at every video frame. Every video frame can be transcoded before being encoded (e.g. using base 64) into an HTML display compatible-standard graphic image. Then the standard graphic image can be fed into a stream that can be compressed, streamed back to the browser via a content delivery network (CDN) or transcoding server (see FIG. 2), and saved for future rendering of the same video. The stream compression can be accomplished using a lossless compression algorithm, such as gzip. This can help to reduce the size of data transmission offering numerous benefits including better efficiency. The JavaScript file running in the web browser at the device will receive the compressed, encoded video stream and can then load the encoded video frames in an image or graphics display element such as an HTML image element, HTML canvas element, or others. This display element can displays the video frames in the web browser and updates the image element with the corresponding video frame image at the frame rate of the video. An example is a 30 frames per second video where the video frames loaded in the image element would be updated every 33.33 milliseconds.

In some embodiments, image quality and frame rate for a video may be adjusted based on network speed in order to render the visual channel smoothly. In some embodiments buffering can be available or optional. A JavaScript file can buffer up to one second's worth of frames for a visual channel before beginning playback of the video. Once the JavaScript file begins playback of the video on the user device, the remainder of the user frames can be downloaded and played. Where the network is providing a slower connection speed, the JavaScript file can function to control one or both of a frame rate and quality drop dynamically. For instance, the system could drop the frame rate from thirty frames per second to twenty-four frames per second and an image quality drop by twenty-five percent in order to smoothly stream. This provides device users with a seamless experience without video stopping or skipping that is noticeable by the user. This improves user experience and as such, can better hold user attention and deliver advertising messages.

An audio channel associated with the visual channel can be formatted in a standard format for the mobile device such as AAC, MP3, or others and streamed to the web browser via an embedded HTML5 audio element. The audio element and image element playback can then be synched together by the JavaScript file. The JavaScript file can continuously monitor playback of both the visual and audio channels to ensure they are synched and at a proper frame in playback. In the event that either the audio or visual falls behind or they are otherwise desynchronized, the JavaScript File can reduce the frame rate or quality to better suit the network connection and resources of the device.

To reduce the amount of data transferred when users are on cellular networks (as opposed to Wi-Fi or other networks) or have slow connections, the visual channel of the video may be streamed at a lower frame rate or image quality and the audio channel, which is decoupled from the visual channel, may not be streamed to the device until or unless the device user requests it. In an example embodiment, a visual channel of a video can be played and include a “click here for audio,” “unmute,” or other comparable button which is selectable by a user, for instance by touching an appropriate location on a touchscreen device. Thus, audio may not be played until the user selects “click here for audio”, “unmute” or other comparable button. Selection of a “click here for audio”, “unmute” or comparable button can cause execution of a stored algorithm causing the audio channel to begin downloading. The visual channel can continue playing without pausing and audio can begin playing at an exact time, such that it is synchronized with the visual channel (e.g. 5.07 seconds from video channel start), once a predetermined quantity of the audio channel data has been downloaded. This allows for synchronization during playback of both audio and visual channels and seamless transition from play of the visual channel alone to play with both visual and audio channels.

Having decoupled audio and visual streams provides numerous advantages over traditional video that downloads both audio and visual channels regardless of whether a user desires to hear audio during a video advertisement or video content rendering. At least one of these advantages is that less data is initially downloaded, reducing the length of time between the webpage loading and the start of video rendering. Another advantage is a reduction in the amount of bandwidth required and used by users, thus potentially saving them money on their cellular contracts.

Other systems, methods, features and advantages of the invention, such as an ability to “auto play” video, where a plugin or native device video player may not otherwise support it, will become apparent to one with skill in the art upon examination of the following figures and detailed description. It is intended that all such additional systems, methods, features and advantages by included within this description, be within the scope of the system and methods described herein.

The configuration of the devices described herein in detail are only example embodiments and should not be considered limiting. Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A shows an example embodiment of a system diagram.

FIG. 1B shows a diagram of a server system according to an embodiment of the invention.

FIG. 1C shows a diagram of a mobile device according to an embodiment of the invention.

FIG. 1D is a diagram depicting further detail of mobile device which can be an Internet connected mobile device.

FIG. 2 is a flowchart showing an example embodiment of a transcoding operation for a mobile device

FIG. 3 shows a diagram depicting an example embodiment of a Video container on a webpage that a script can update with images and audio for a video.

FIG. 4 shows a flow of transcoding HTTP-request according to an example embodiment.

FIG. 5 shows a diagram depicting an example embodiment of script functions.

FIG. 6 shows a diagram depicting an example embodiment of an Auction Flow.

FIG. 7 shows a user interface diagram depicting an example embodiment of an account summary and display of various metrics gathered from tracking video activity.

FIG. 8 shows a user interface diagram depicting an example embodiment of a supply management page.

FIG. 9 shows a user interface diagram depicting an example embodiment of a demand management page.

FIG. 10 shows a user interface diagram depicting an example embodiment of a video advertisement rendering as the result of running a script.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

Provided herein are systems and methods of providing media files such as video including audio and visual components to web browsers on mobile devices.

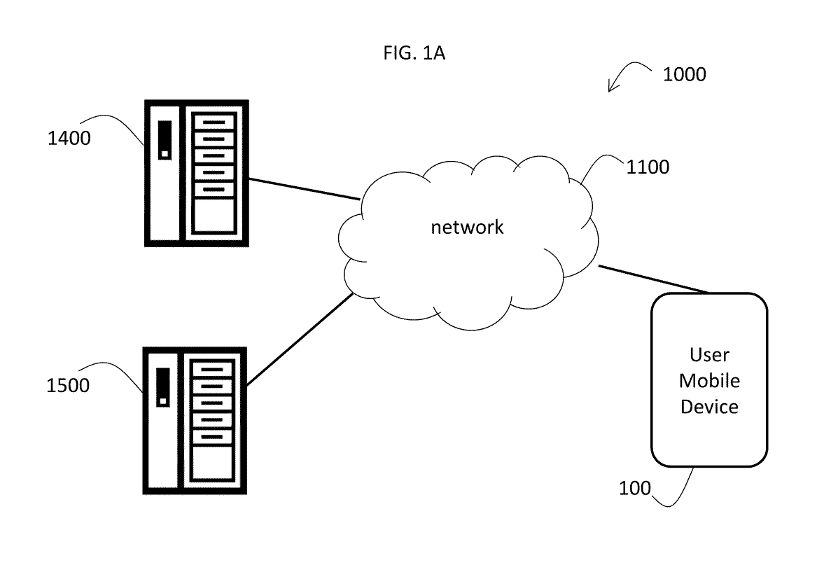

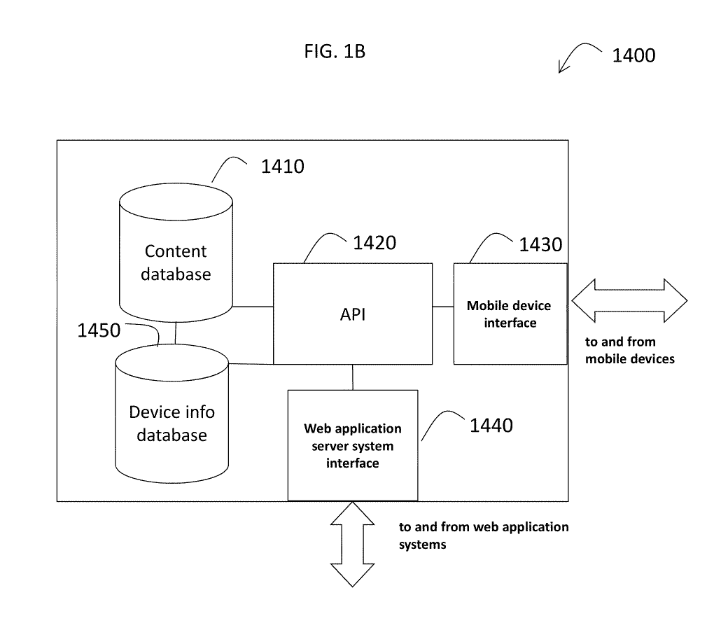

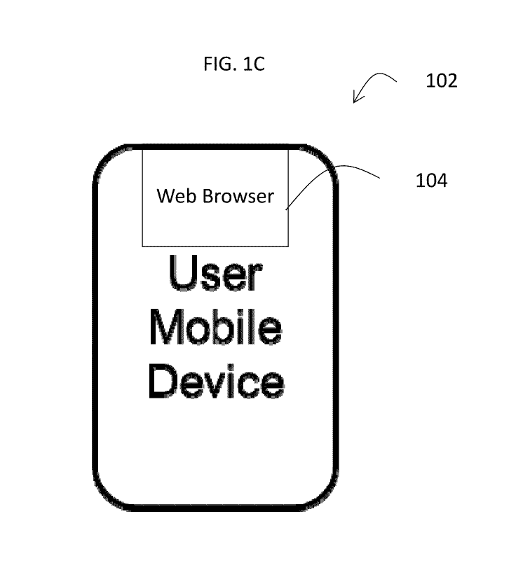

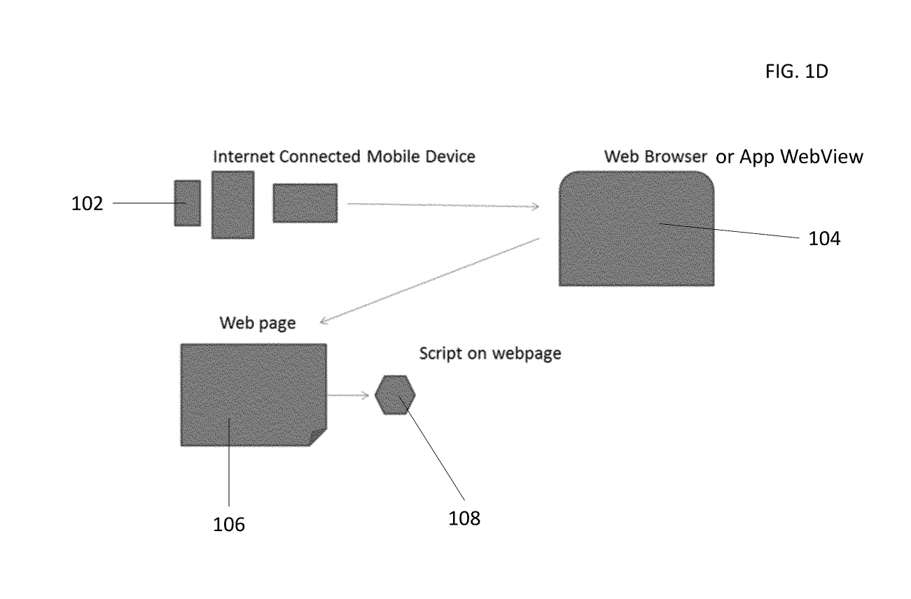

FIG. 1A shows an example embodiment of a system diagram with multiple servers 1400, 1500 which may include applications and databases distributed on one or more physical servers, each having one or more processors, memory banks, operating systems, input/output interfaces, network interfaces, power sources and regulators, and other necessary components all known in the art, and a plurality of mobile user devices 100 coupled to a network 1100 such as a public network (e.g. the Internet and/or a cellular-based wireless network, combined wireless/wired network or other network) or a private network. User mobile devices 100 include for example smartphones, tablets, or others; wearable devices such as watches, bracelets, glasses; other devices with computing capability and network interfaces and so on. The server system includes, for example, servers operable to interface with websites, webpages, web applications, social media platforms, advertising platforms, and others.

FIG. 1B shows a diagram of a server system 1400 according to an embodiment of the invention including at least one mobile device interface 1430 implemented with technology known in the art for communication with mobile devices. The server system 1400 also includes at least one web application server system interface 1440 for communication with web applications, websites, webpages, websites, social media platforms, and others. Server system 1400 may further include an application program interface (API) 1420 that is coupled to one or more of a content database 1410, device information database 1450, other databases, or combination thereof and may communicate with interfaces such as mobile device interface 1430 and web application server system interface 1440, or others. API 1420 may instruct a device information database 1450 to store (and retrieve from the database) information such as mobile device information including one or more of manufacturer, model, make, browsers installed, geographic location, time and date information or others as appropriate. API 1420 may also store and retrieve content from content database 1410 associated with device information. Databases may be implemented with technology known in the art such as relational databases and/or object oriented databases or others.

FIG. 1C shows a diagram of a mobile device 102 according to an embodiment of the invention. In many embodiments mobile devices 102 are touch screen smartphone devices or similar tablet devices. Smartphone devices typically include processors, network communication interfaces, power sources, software stored in non-transitory memory and executable by processors, other memory, user interfaces, displays, operating systems, audio input and output systems, circuitry and other modules, systems and interfaces as known in the art, connected and operable to create a functional device. Mobile devices 102 also include one or more web browsers 104 which can be manufacturer installed on the device or downloaded, pushed to or pulled to the device in the form of an application developed by a manufacturer or third party.

FIG. 1D is a diagram depicting further detail of mobile device 102 which can be an Internet connected mobile device. An Internet connected mobile device 102 such as a tablet, smartphone or other device can include a Web browser or app WebView 104 installed on mobile device 102 and including a user interface displayed on a display of mobile device 102. Web browser or app WebView 104 can include user interaction capability by way of a keyboard, buttons, touchpad, touchscreen, or other user input of mobile device 102. Web page 106 can be accessed via Web browser or app WebView 104 on mobile device 102 and can include a website on a network such as the Internet. Script 108 can be a small, non-compiled program written for a scripting language or command interpreter included on webpage 106 for requesting and rendering a video including visual and audio channels.

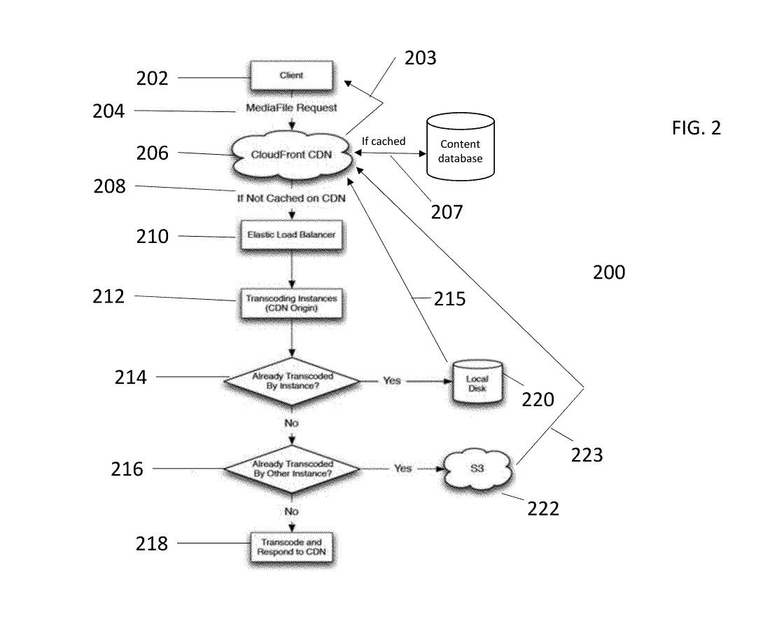

FIG. 2 is a flowchart 200 showing an example embodiment of a transcoding operation for a mobile device. In the example embodiment a client 202 can run a Script on a webpage in a web browser or app WebView which creates a video container and prepares a media file request 204 for a transcoded version of the visual and, optionally, the audio content of the specified media file. Media file request 204 can be based on video content to be streamed back to the webpage of the requesting mobile device (client) at a predetermined frame rate and image quality. In some embodiments, media file request can be an XMLHTTPRequest.

Request for a media file 204 such as a video file with visual and audio channels is sent from the script to at least one servers with connected content databases such as on a CloudFront Content Delivery Network (CDN) in 206. In some embodiments, the formatted visual and audio content can be previously stored and available for quick delivery if they have been previously processed (transcoded) and are available on the CDN for delivery. If the requested media file has already been formatted, it can be stored on a database of a server connected to the CDN for retrieval via quick access and streamed from database to the CDN in 207 and back to the client in 203. To elaborate, the CDN contains the already transcoded files that are available on a distribution network for nearly instant streaming. If the requested video is a video that has not been used on the system before, the CDN will not have it stored, since it has not yet been transcoded, so the CDN will have to defer or pass the request on to a transcoding server via an Elastic Load Balancer.

As mentioned above, if the requested transcoded media file is not stored on the CDN, in 208 the request can be sent to an Elastic Load Balancer in 210 which is in charge of distributing traffic amongst the server cluster of machines of the CDN. The Media file request can be routed through Elastic Load Balancer that handles distributing traffic evenly amongst a server cluster of transcoding server instances in 212. A transcoding server can receive the request for the transcoded media file and determine in step 214 if it has already transcoded the media file and if so, how recently. The server can pull the transcoded media file from storage 220 such as a local disk on transcoding server instance, which can be a hard drive, and stream it back to the CDN in 215 and then to the client in 203. The transcoded version of the specified video, including visual and audio files can then be stored on the CDN for future streaming.

If the server has not transcoded the media file, the server can determine if any other server has transcoded the media file and whether it is available in an online file storage web service environment where all machines in the server cluster place their transcoded media files, including visual and audio video files, such as Amazon's S3 in step 216. If the transcoded media file is available in the online file storage web service which can be used to store and retrieve vast amounts of data from anywhere on the Internet, it can be accessed and streamed back the CDN in 223 and then on to the client in 203. The transcoded version of the specified media file including visual and audio files can then be stored on the CDN for future streaming.

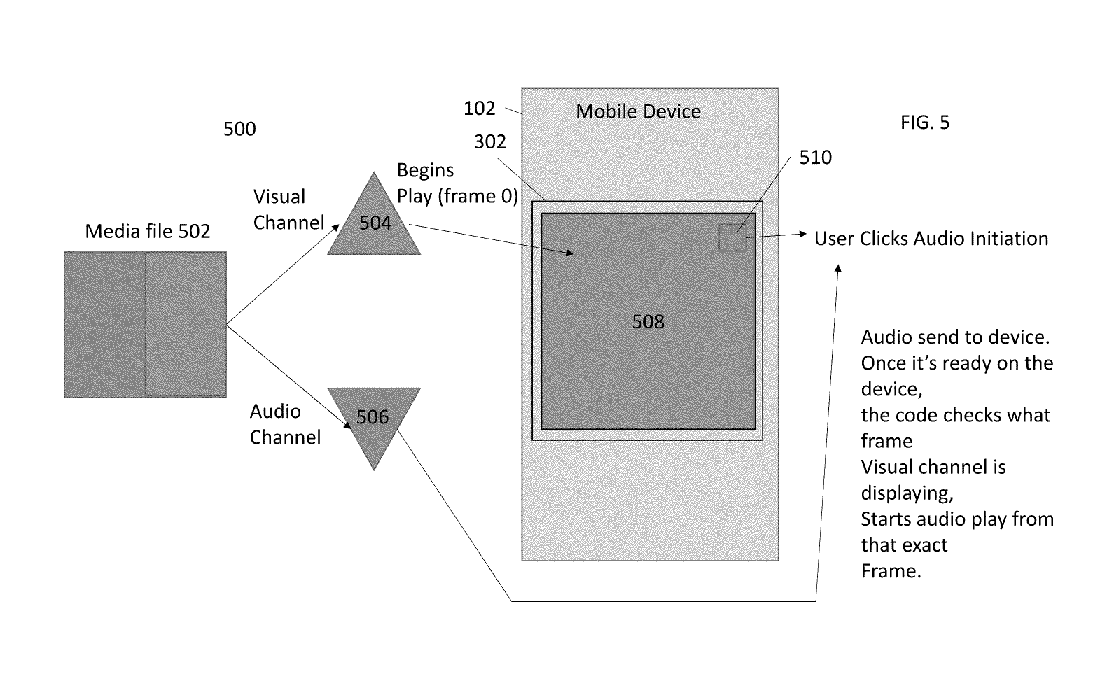

If the content has not been transcoded by another instance or cannot be found on the shared cloud storage, then in 218 transcoding server can decode the media file, separate the audio and visual channels, and convert the visual channel frame by frame to display compatible images, such as in HTML, and the audio channel to a standard compatible format. In an example embodiment, for the visual channel, every visual frame can be decoded then encoded using base 64 into an HTML display compatible standard graphic image, then compressed using lossless gzip compression (to reduce the size of data) as it is streamed back to the web browser or app WebView via the CDN, where the JavaScript file will process it. The visual and audio files can be sent separately and the audio file may not be sent until requested in some embodiments, as described below with respect to FIG. 5. The transcoded version of the specified visual and audio files can then be stored on the CDN for future streaming. The streaming of both visual and audio frames from the transcoding machine to the client can occur when each individual frame is ready rather than at the completion of the transcoding process so that rendering can begin as quickly as possible for the user. The transcoding machine can also store the formatted media files on its local disk on a FIFO (First In, First Out) basis. In addition to local disk storage, the transcoding machine can also store a copy of the formatted media files on the online file storage web service 222 where other transcoding servers can access them in order to prevent resource waste which may occur if the same files are transcoded multiple times on multiple servers.

The transcoding server can then store this transcoded output in memory, such as on a disk, for a preset period of time and add it to an online file storage web service such as the CDN. The transcoded output can also be streamed back to the client JavaScript file operating on the mobile device via the CDN.

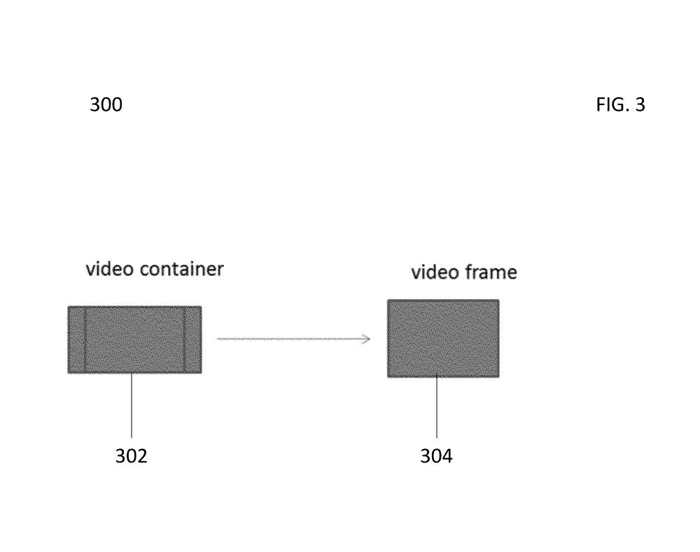

FIG. 3 shows a diagram 300 depicting an example embodiment of a Video container 302 on a webpage that a JavaScript can update with HTML compatible images for each video visual frame of a video. Video frames 304, for instance including HTML compatible images, can be updated within video container 302 according to the frame rate of the associated video.

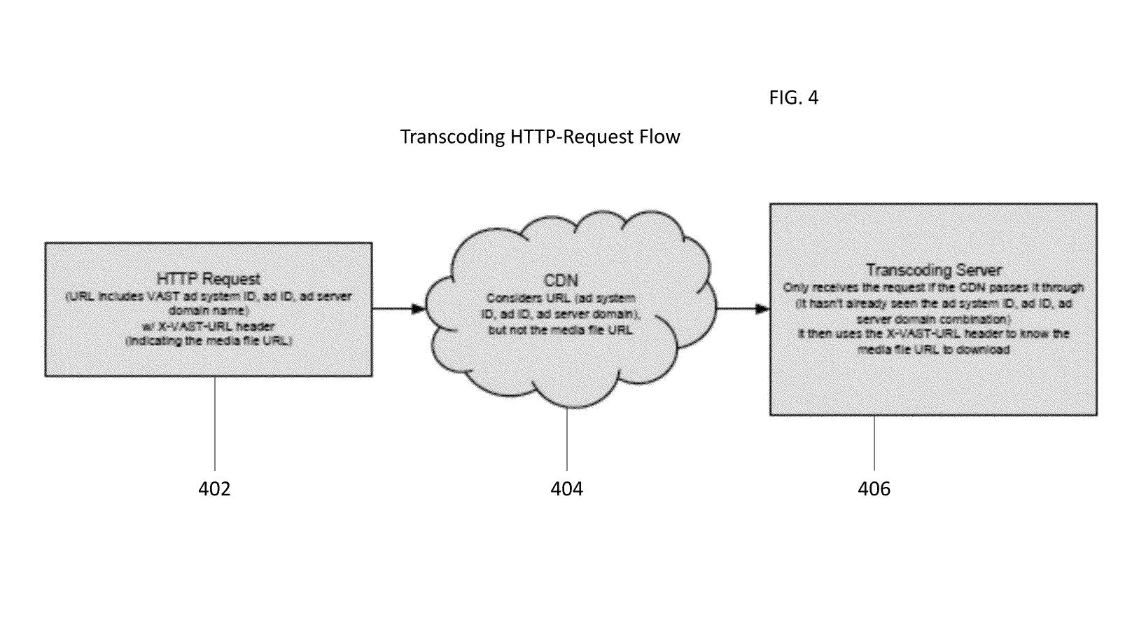

FIG. 4 shows a flow of transcoding HTTP-request according to an example embodiment. In the example embodiment an HTTP Request 402 can include be a URL including Video Ad Serving Template (VAST) ad system ID, advertisement ID, advertisement server domain name with a X-VAST-URL header indicating the media file URL. This can be sent to a CDN 404 which can consider the URL including the advertisement system ID, advertisement ID, advertisement server domain but not the media file URL in order to be able to recognize similar media files even if they have a unique media file URL on each individual occurrence of the media file. This can be sent to the transcoding server 406 which can receive the request if the CDN passes it through. This can include the transcoding server not seeing the advertisement system ID, advertisement ID, advertisement server domain combination. The transcoding server 406 can then use the X-VAST-URL header to determine the media file URL to download. These steps can represent a more detailed view of how a media file request is determined within the system in step 204 of FIG. 2.

A user of an Internet connected mobile device such as a smart phone or tablet 102 (see FIGS. 1A, 1C, 1D) can access a webpage 106 of a website (see FIG. 1D) using a web browser or app WebView 104 (see FIGS. 1C, 1D). Included in webpage 106 can be a script 108, which can be JavaScript or others, which can perform a number of functions, including but not limited to:

A) Locating or creating a video content container 302 where video frames 304 can render (see FIG. 3, 5). For instance, a website can indicate which element should be used in a container if desired and the system can locate the element and use it instead of creating one.

B) Determining web page data including one or more of URL, domain, or other information to ensure that desired video content, which can be an advertisement, can run according to parameters defined by an associated content owner, who can be an advertiser. Some example embodiments exist where an advertiser has defined a whitelist of allowed or acceptable domains. As an example, a dog food advertiser may wish to have their content appear on a webpage about responsible dog owners.

C) Determining if the video content will be rendered in the viewport of the mobile device. This determination can include checking if the webpage in an active tab of a web browser and if the web browser has been scrolled to a position where the video content container would be visible to a user, also referred to as “viewability.”

D) Determining a browser type and version. Since some content providers prefer to perform targeted advertising using this information. This determination can also be useful in protecting against fraud, since a nefarious user may spoof a machine to appear as if it is a mobile device in an attempt to commit fraud.

E) Determining user identification and preference data for aiding in deciding video content to display. This information can include a device ID, an assigned user ID, website preferences, demographic information, or others.

F) Determining a device type, model, hardware, installed applications, previous web history, or other information.

G) Determining network connection speed and network carrier.

H) Identifying at least one media file such as video content or advertisements to render in the video content container of “A” above.

I) Making a request to a CDN to initiate a stream of the media file. Initially this can include only the visual stream.

J) Processing the initiated stream of the media file which is received, having a particular format.

K) Updating the video content container with visual frames according to a playback rate of the media file and the user's connection and device speed. Buffering may be optional as described previously.

L) Initiating an audio stream with audio frames that is associated with the visual stream, including an HTML5 audio element if applicable, and audio playback if desired by the user. This can occur once a user has selected a button to being audio playback.

M) Syncing the audio and visual streams to the same frame and adjusting playback if either stream falls behind or they become otherwise desynchronized.

N) Tracking playback time, user engagement, and other applicable video advertisement and video content metrics. Some of these metrics can be defined by the video content provider or advertiser while others may be system defined.

O) Enabling click through of the video stream to a content provider or advertiser's website associated with the video. This can occur if a user selects a particular screen location with a button during a video.

For video advertisements, the decision of which advertisement should be delivered can occur in real-time. The JavaScript file can facilitate this decision by making requests to various advertising sources, prioritizing the best advertisement for the web page, which may be based on predetermined factors such as price or delivery levels for the particular website, and identifying at least one video media file of the advertisement. With these systems and methods, video media files in numerous formats can be delivered to users because the files can be transcoded in real-time to a format that is operable to play on devices that support a particular script, such as JavaScript, and standard HTML image graphic displays and are connected to a network including but not limited to the Internet.

Functioning of a Script

In some embodiments, script 108 can be a JavaScript file which can receive streamed data of a formatted video media file including at least one of visual or audio data. The JavaScript file can delay playback until a predetermined adequate number frames of the media file have been received so that the JavaScript file will be able to simultaneously stream the remainder of the media file and render received frames at the same time. Determination of whether an adequate number of frames of the media file have been received can be calculated based on the amount of time required to stream each frame and the number of frames in the media file.

The JavaScript file can update the visual frames 304 of FIG. 3 to be displayed in the video container 302 by updating an HTML compatible image at a specific frame rate. For example, with a 30 frames per second video file, the image can be updated every 33.33 milliseconds. At a user's direction, such as by selecting an “unmute” button on a device display, the JavaScript file can also synchronize the audio channel to the same frame as the visual channel playback and begin playback of the audio channel via an HTML5 audio element. This can occur, for instance, at a specific frame. During video file playback, the JavaScript file can monitor whether the audio and visual frames are synced and at a correct position in the playback. A correct position in the playback can be a specific point related to the start of playback, for example at 3.1 seconds playback of the media file. If the audio and visual frames are not synced or at the correct position in the playback, the JavaScript file can make adjustments to speed up or slow down one or both of the audio and visual channel playback, for instance by delaying one or both as appropriate. If, while monitoring one or both of the device's resources and network connections, the JavaScript file determines that one or both of the resources and connections are not able to keep up with the playback settings, such as the playback frame rate of the original media file, then the image size, quality, and/or the overall frame rate may be reduced to a lower setting. This lower setting can be manifested as one or both of fewer frames per second and lower image quality.

The JavaScript file can also track metrics important to video content providers, such as advertisers, including times when specific points in playback are reached, such as: Start, 25%, 50%, 75%, 100%, or others.

In addition, as desired by a content owner or advertiser, the JavaScript file can enable a portion or all of the video to be clicked on or selected by the user and thus direct the user to a landing page, other installed application, or website related to the video content or defined by the advertiser while simultaneously monitoring the event. Furthermore, media files are not limited in any additional tracking of playback, engagement or providing additional layers of interaction in or around the video container. An example embodiment of providing additional layers of interaction in or around the video container is for an advertiser to request the system to layer over a quadrant of the video with a call to action based on a day of the week, time of day, geographical position of a device, or other trigger.

Turning to FIG. 5, a simplified version of the above functions of the script is shown. In the example embodiment a Media file 502 can be separated into a visual channel 504 and audio channel 506 by a transcoding process. The visual channel 508 can begin playback in video container 302 on mobile device 102 and if a user selects an “unmute” button 510 then audio channel can begin from the exact frame the visual channel is at, synchronizing the audio and visual channel playback.

Ad Decisioning Platform

An Ad Decisioning Platform can service content Publishers such as websites and applications with advertisement inventory, Publisher Aggregators such as “ad networks” which represent multiple websites, applications or a combination of the two, and Advertisers brands, agencies, and their online ad partners and intermediaries.

The Ad Decisioning Platform can provide Publishers and Publisher Aggregators with the ability to maximize their overall revenue by choosing an advertisement with a highest payout that is considered eligible for the current advertisement impression request. Fixed rate and dynamic rate advertisements may be used. Dynamic rate deals receive bids for user views, which can be compared against other dynamic rate deals and against fixed rate deals. Based on this, the highest payout can be the highest amount of revenue for the publisher.

The Ad Decisioning Platform can provide Advertisers and Publishers with the ability to target advertisements, pace the rate of ad delivery over a period of time, and cap the number of advertisements served during a period of time.

Targeting can be accomplished using one or more of the following criteria:

A) By type of device such as smartphone, tablet, Internet connected TV, personal computer, video game console, or others.

B) By operating system of device such as iOS, Android, Windows or others and also by operating system version.

C) By web browser such as Google Chrome, Apple Safari Mobile or others.

D) By geographic location such as latitude, longitude, zip code, city, state, country, DMA, or others.

E) By Internet Service Provider such as Cox Communications, Verizon Wireless, or others.

F) By advertisement type such as video, static banner, or others and by advertisement size.

G) By website such as http://www.samplewebsite.com.

H) By custom defined “user data” attributes such as demographics, behavior, preferences, or others.

Likewise, Pacing can be affected by numerous criteria:

A) Throttling the advertisements delivered per hour to ensure even delivery of a goal amount per day.

B) Throttling the advertisements delivered per day to ensure even delivery of a goal amount per defined period of days.

C) Throttling the advertisements delivered per hour and per day to ensure even delivery of a goal amount per day and per defined period of days.

D) Throttling the advertisements delivered per hour according to a goal amount per day and according to normal web traffic distribution rates per hour. One example is 75% less advertisements delivered at lam than at 1 pm.

E) Numerous other throttling mechanisms based on specific algorithms.

Similarly, Capping can be accomplished according to the following example criteria:

A) By frequency of user being exposed to advertisements over a defined period of time, for example 3 advertisement impressions per 24 hours.

B) By a number of advertisement impressions over a defined period of time, for example 1,000,000 impressions over 24 hours.

A Platform User can input their Ad Deals from Advertisers into an Ad Decisioning Platform with details about the revenue (for example $5.00 CPM—Cost Per Mille) for each deal and any targeting, pacing, or capping defined by the Publisher or the Advertiser.

When the Ad Decision Platform receives a request it will use the data available with the request for targeting. The Ad Decision Platform can eliminate Ad Deals based on targeting mismatches. Furthermore, the Ad Decision Platform can check Ad Deal caps and pacing to further determine eligibility. After determining which Ad Deals are eligible the Ad Decision Platform can check each Ad Deal to ensure there is an Ad by making a request to the predefined ad URL and ensuring a response indicates an Ad is available at the time requested, for instance if there is a technical error or if an Ad provider enforces one or more of its own targeting, capping and pacing. Ensuring there is an Ad may be important if no Ads are eligible based on preset criteria. For example, if geography limits are set such that an advertiser only has Ad Deals in the United States and the user is located in Canada then there may be no eligible Ads at the current time.

In addition, if the Ad Deal has a dynamic price, referred to herein as a “bid,” per impression, the Ad Decisioning Platform can send a request to the Ad Deal's predefined URL and examine the response to determine if an ad is available and the “bid” the Advertiser is willing to pay for the advertisement impression. The Ad Deal price may not be fixed and thus the Publisher may choose to accept and run an Ad Deal's Ad or ignore the Ad in favor of a higher paying fixed rate Ad Deal or a higher paying bid when bidding is used.

The Ad Decisioning Platform can determine the eligible Ad Deal with the highest price which can be predefined or “bid,” and choose it as the Ad to load on the page, thus maximizing a Publisher's advertising revenue. By prioritizing selecting the advertiser, via an Ad Deal, that is going to pay the publisher the most money on each Ad impression, publishers will likely make more money than if the publishers were to select advertisers via a round robin or other non-revenue focused ad decisioning process and/or system.

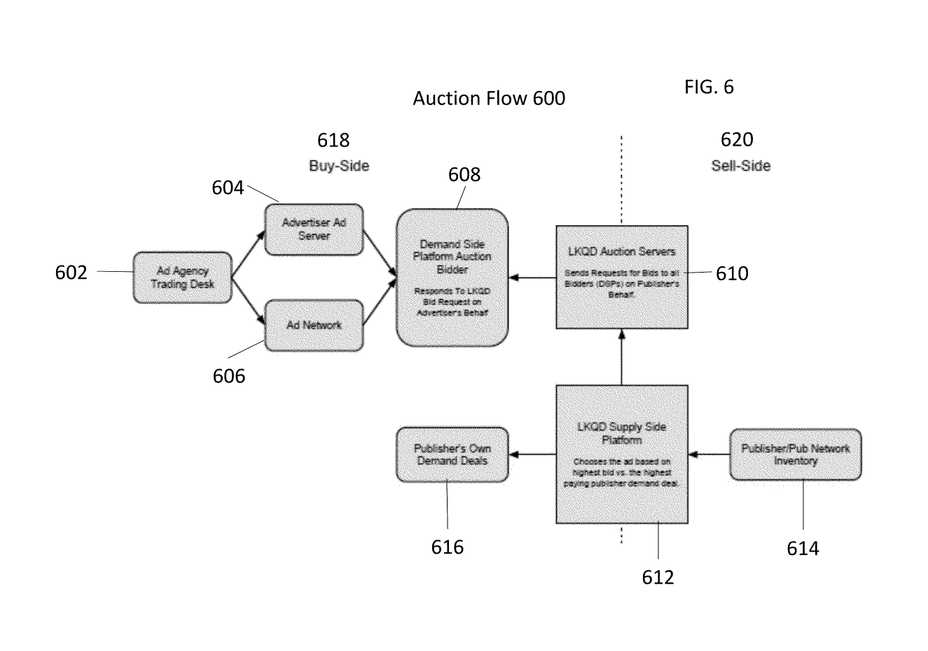

As described above, an Auction Flow 600 can be seen in FIG. 6. On a Buy-side 618, an Ad Agency trading desk 602 can send advertisements to one or more of an Advertiser Ad Server 604 and Ad network 606. These can both send advertisements to a Demand Side Platform Auction Bidder 608 which can respond to a system bid request on the advertiser's behalf according to criteria described above. A System Supply Side Platform 612 can select an advertisement based on a highest bid as compared with a highest paying publisher demand deal acquired from a Publisher/Pub Network Inventor 614 on a sell side. The System Supply Side Platform 612 can set Publishers Own Demand Details in 616. Then the System Supply Side Platform 612 can send requests for bids to all bidders on a Publisher's behalf at System Auction Servers which in turn communicate these to the Demand Side Platform Auction Bidder 608.

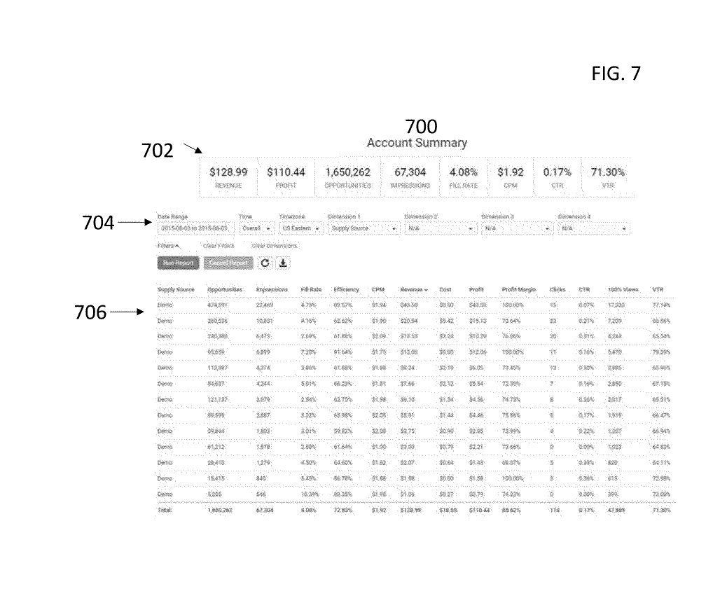

FIG. 7 shows a user interface diagram depicting an example embodiment of an account summary 700. In the example embodiment a brief summary area 702 can include information such as revenue, profit, opportunities, impressions, fill rate, CPM (Cost-per-Mille—cost per thousand impressions), CTR (click through rate), VTR (view rate where 100% of video is viewed) and others. These can give a user a simple overview of the particular account the user is currently viewing. Customization area 704 can include information such as a date range, time, time zone, dimension 1, dimension 2, dimension 3, dimension 4 and others. These allow the user to customize the data they are viewing based on a variety of definable metrics in order to view specific data. A Detailed description area 706 includes detailed information regarding each of the advertisements currently being run through the system including supply source, opportunities, impressions, fill rate, efficiency, CPM, Revenue, Cost, Profit, Profit Margins, Clicks, CTR, 100% Views, VTR, and others. These allow a user to view a detailed breakdown of each of the advertisements currently used in the system for the particular account and see the performance of each in comparison to others. This can be valuable for users who wish to evaluate advertisements on a case by case basis.

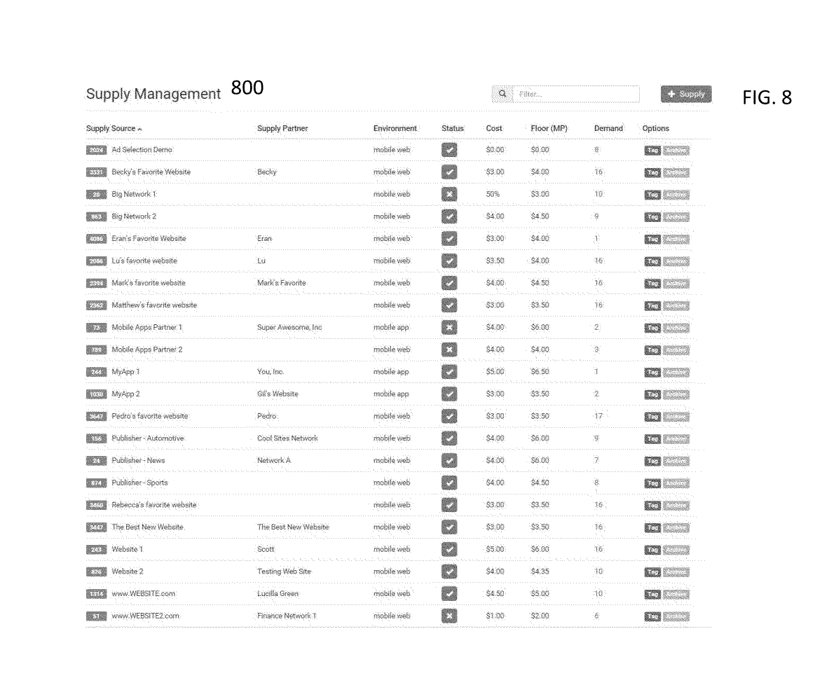

FIG. 8 shows a user interface diagram depicting an example embodiment of a supply management page 800. In the example embodiment a user can view a supply source, supply partner, environment, status, cost for running ads on website, floor (lowest price) the supply source will allow ads to run at, demand, options, and other information. As an example, the second line depicts a particular website supply source “Becky's Favorite Website.” The supply partner is “Becky” and the environment is a mobile webpage. The status is currently enabled for delivering ads and the cost is $3.00 while the floor is $4.00.

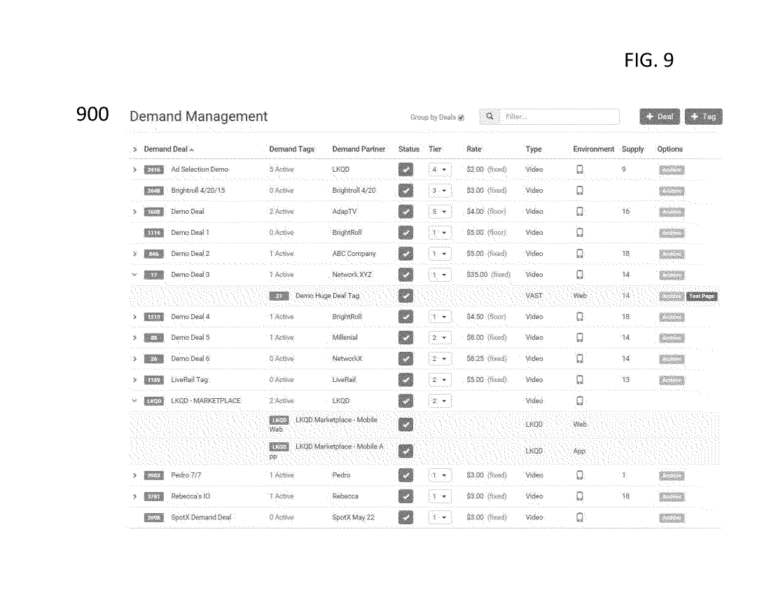

FIG. 9 shows a user interface diagram depicting an example embodiment of a demand management page 900. In the example embodiment a user can view a demand deal, demand tags, demand partner, status, tier, rate, type, environment, supply and options. As an example, the first line shows a demand deal for “Ad Selection Demo.” This deal has 5 active demand tags and has a partner LKQD. It is currently an active status with tier 4 and a $2.00 fixed rate. It is a video type advertisement on a mobile environment with 9 supply sources enabled for ads and an option to archive.

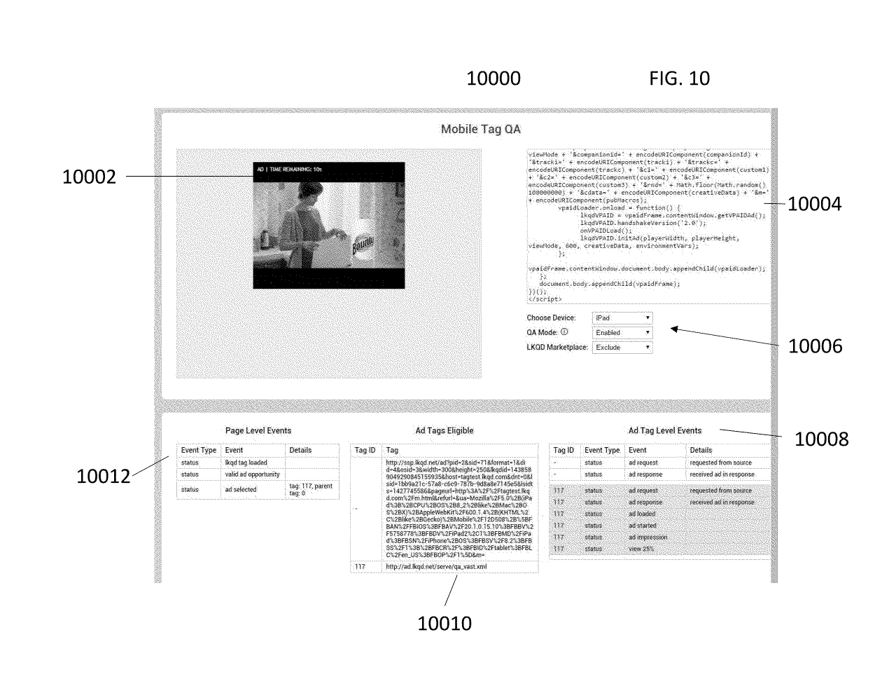

FIG. 10 shows a user interface diagram depicting an example embodiment of an advertisement management page 10000. In the example embodiment an example 10002 shows how an advertisement will appear on a mobile device. Coding 10004 shows particular coding for the advertisement. Applicability options 10006 include dropdown menus which can be used to select the type of device, QA mode and if the marketplace will be applied. These can also be accomplished in other manners, particularly by radio buttons, point and click checkboxes, or others. Ad Tag Level Events 10008 show advertisement functionality event triggers. Ad Tags Eligible 10010 shows one or more tags which are eligible meaning that it meets all criteria to deliver an ad in this scenario. Page level events 10012 show event types, events, and details for the advertisement.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A media file transcoding system, comprising:
a script stored in non-transitory memory and executable by a processor which, when executed by the processor:
creates a video container on a mobile device;
receives a media file from a server;
splits audio and visual data apart;
begins playback of visual data in the video container while monitoring resources;
upon selection of a button by a user begins playback of audio data at a predetermined point of the visual playback;
monitors synchronization of audio and visual playback; and
monitors metrics.

2. The media file transcoding system of claim 1, wherein monitoring resources further comprises monitoring device resources.

3. The media file transcoding system of claim 1, wherein monitoring resources further comprises monitoring network resources.

4. The media file transcoding system of claim 1, further comprising:
determining if the synchronization of audio and visual playback has been interrupted and, if there has been interruption, delaying one of the audio or visual data until synchronization is achieved.

5. The media file transcoding system of claim 1, further comprising:
determining if the synchronization of audio and visual playback has been interrupted and, if there has been interruption, reducing one or both of image quality or frame display rate.

6. A method of media file transcoding, comprising:
a client device requesting from a first server whether a transcoded media file is available:
if the transcoded media file is available, providing the transcoded media file to the client device, or
if the transcoded media file is not available, passing through an elastic load balancer to a transcoding server instance
the transcoding server instance determining whether the transcoded media file is available on a shared network file storage or another server within the same load balancer server cluster:
if the transcoded media file is available, sending the transcoded media file to the client device, or
if the transcoded media file is not available, then transcoding the media file, sending the transcoded media file to the client, and storing the media file for future use in memory and on shared network file storage.
